(19) United States
(12) Patent Application Publication
(10) Pub. No.: US 2009/0223886 A1
(43) Pub. Date: Sep. 10, 2009

(54) Water Purification Apparatus

(76) Inventor: Shi Chun Yang, Ulsan (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/162,853

(22) PCT Filed: Jan. 12, 2007
(86) PCT No.: PCT/KR2007/000222

§ 371 Date: Dec. 11, 2008

(30) Foreign Application Priority Data
Feb. 3, 2006 (KR) 10-2006-0010690

(51) Int. Cl. C02F 1/00

(52) U.S. Cl. 210/170.05

(57) ABSTRACT

The water purification apparatus includes a purification tank, which is disposed in water such as a lake, marsh, river or sea and has a structure such that at least the sidewall and the bottom thereof are closed to contain sewage. The apparatus further includes purification devices, which are provided inside or outside the purification tank to purify sewage, and floats and which support the purification tank and the purification devices to prevent them from sinking in the water. Therefore, the present invention can be easily disposed on water through a simple installation process, and can be used in a water treatment system. Furthermore, the present invention can treat sewage more efficiently and in a more environmentally friendly manner. Particularly, compared to a land installation method, the present invention can markedly reduce installation expenses and space and makes it easy to install, move and remove the system.

### TECHNICAL FIELD

The present invention relates, in general, to water purification apparatuses and, more particularly, to a water purification apparatus which has a structure that makes it possible to provide a water purification system on water in a place, such as a lake, marsh, river, sea, etc., thus treating water efficiently and in an environmentally friendly manner.

### BACKGROUND ART

Recently, environmental pollution is becoming serious in proportion to the increase in the total amount of waste attributable to industrial development and the acceleration of mass consumption by humans. Particularly, pollution levels in lakes, marshes and harbors, where pollutants collect, have increased geometrically over the years.

Therefore, in the case of lakes, marshes or harbors, water treatment for removing pollutants from internally polluted water or inflow polluted water is required. However, because there is generally a large amount of objects and many tributaries, the current method of treating sewage using heavy land-based equipment cannot conduct the desired level of treatment due to the economical burden.

In other words, conventional sewage treatment equipment, which is constructed using heavy concrete structures and has been typically operated on the ground, requires relatively large installation space and incurs high construction expenses. Furthermore, there are disadvantages in that the construction time is relatively long, and expansion, modification and removal of the sewage treatment structure is not easy.

In an effort to overcome the above problems, a sewage purification technique was proposed in Korean Patent Registration No. 10-269422, which is entitled ‘floating type sewage purification apparatus and method of purifying sewage using the apparatus’. The technique disclosed in the registered patent mentioned above will be described herein below with reference to FIG. 1.

FIG. 1 is a schematic view showing the purification apparatus according to the patent mentioned above.

As shown in FIG. 1, the conventional purification apparatus includes a treatment tank 1, which defines a water space therein to contain a predetermined amount of water therein, and a float 5, which helps the treatment tank 1 float on water. A plurality of biological carriers 4 is provided in the treatment tank 1, and an inlet port 2 and an outlet port 3 are provided in the treatment tank 1.

The treatment tank 1 comprises a sidewall, which surrounds the water space to a predetermined depth, and is constructed such that a bottom thereof is unnecessary. A skirt part 8, which is open on the lower end thereof, is provided on the lower end of the treatment tank 1 to prevent sewage in the treatment tank 1 from being discharged outside the treatment tank before it is sufficiently purified.

Furthermore, partition walls 6 are installed in the treatment tank 1 to increase the time for which sewage contacts the biological carriers 4 and ensure that the sewage remains in the treatment tank for a sufficient amount of time.

Meanwhile, a shading means 7 is placed on the upper end of the treatment tank 1. A plastic sheet or a plate made of a well known material is used as the shading means 7.

The biological carriers 4 are installed in the treatment tank 1 to form a structure such that the biological carriers 4 are hung on support rods 12 provided in the upper end of the treatment tank 1. A diffusing means 9 for efficiently oxidizing and resolving pollutants using microbes in the biological carriers 4 is disposed in the lower end of the treatment tank 1. The diffusing means 9 is coupled to a pump 11.

In the drawing, the reference numeral 10 denotes a means such as an anchor for fixing the apparatus at a desired position in the water.

However, in the conventional purification apparatus, which biologically purifies sewage using the biological carriers provided in the upper end of the treatment tank 1, because the treatment tank 1 has a structure such that the lower end thereof is open, there is a problem in that the purifying process is conducted in the state in which the water space defined in the treatment tank is not completely separated from the water in the lake, marsh or river.

Furthermore, in the conventional technique, when polluted water is drawn into the treatment tank 1, sludge or the like contained in the polluted water sinks below the treatment tank. Therefore, there is a problem in that reliable sewage purification cannot be satisfactorily conducted.

### DISCLOSURE

### Technical Problem

Accordingly, the present invention has been made keeping in mind the above problems occurring in the prior art, and an object of the present invention is to provide a water purification apparatus, which is constructed such that a purification tank, the sidewalls and bottom thereof of which are closed, is directly placed in water in a place such as a lake, marsh, river or sea, thus markedly reducing the installation expense of the purification apparatus, reducing the space required for installation of a water purification system, and making it easy to install, move and remove the water purification system.

### Technical Solution

In order to accomplish the above object, the present invention provides a water purification apparatus, including: a purification tank disposed in water of a lake, marsh, river or sea to define a space having a predetermined volume therein, the purification tank being closed on at least a sidewall and a bottom thereof to contain sewage to be purified therein such that the sewage is separated from the outside water; purification devices provided inside or outside the purification tank to purify the sewage contained in the purification tank; and a float supporting the purification tank and the purification devices to prevent the purification tank and the purification devices from sinking in the water.

Preferably, the purification tank may be manufactured using a relatively thin sheet or board.

Furthermore, the purification tank may be constructed such that a width thereof is reduced from a medial portion thereof to at least one end thereof with respect to a direction in which the water flows, to reduce resistance against flow of the water.

In addition, the float may be provided around an upper edge of the purification tank to have a ring shape, such that the water in the purification tank is separated from the water outside the purification tank.

As well, an overflow hole may be formed through at least one of the purification tank and the float, so that the water in the purification tank overflows outside through the overflow hole.

The purification tank may include a plurality of purification tanks, and the purification devices may comprise water purification equipment including an air blower, a pump, a diffuser and a dehydrator, which are required to purify the water.

Moreover, the purification tank may comprise a reaction purification tank, a sedimentation purification tank and a concentration purification tank, which are arranged in series and coupled to each other such that water treatment is conducted in stages, and the purification devices for purifying the water may be disposed inside or outside the purification tanks.

Here, in the case where the purification tank comprises a plurality of purification tanks, and the purification tanks may be coupled to each other in series.

Furthermore, in the case where the purification tank comprises a plurality of purification tanks, the purification tanks may be alternatively coupled to each other to form a structure such that one purification tank receives remaining purification tanks therein.

### ADVANTAGEOUS EFFECTS

The water purification apparatus of the present invention having the above-mentioned construction can be used in a water treatment system that purifies supplied sewage to improve the water quality of a lake, marsh or river, and can be installed on the water in a simple process. Furthermore, the water purification apparatus can efficiently treat sewage in an environmentally friendly manner, even if the sewage contains a lot of biological or chemical oxygen demand substances (BOD or COD substances), floating substances or eutrophic substances such as nitrogen and phosphorus.

In addition, in the present invention, a purification tank for defining water treatment space therein is provided in water using Archimedes' principle. Therefore, compared to sewage treatment equipment that comprises a large concrete structure placed on the ground, construction expenses can be markedly reduced, the manufacturing process is simplified, the apparatus is portable, and the disposal process is also simplified. As well, because the apparatus is not located on the ground, the present invention optimizes use of space.

### DESCRIPTION OF DRAWINGS

FIG. 1 is a schematic view of a sewage purification apparatus of a conventional technique;

FIG. 2 is a schematic view illustrating the basic construction of a water purification apparatus according to the present invention;

FIG. 3 is a schematic side view showing the construction of a first embodiment of the water purification apparatus according to the present invention;

FIG. 4 is a detailed view illustrating an overflow structure, which is a critical part of the water purification apparatus according to the present invention;

FIG. 5 is a schematic side view showing the construction of a second embodiment of the water purification apparatus according to the present invention; and

FIG. 6 is a schematic plan view showing the construction of the second embodiment of the water purification apparatus according to the present invention.

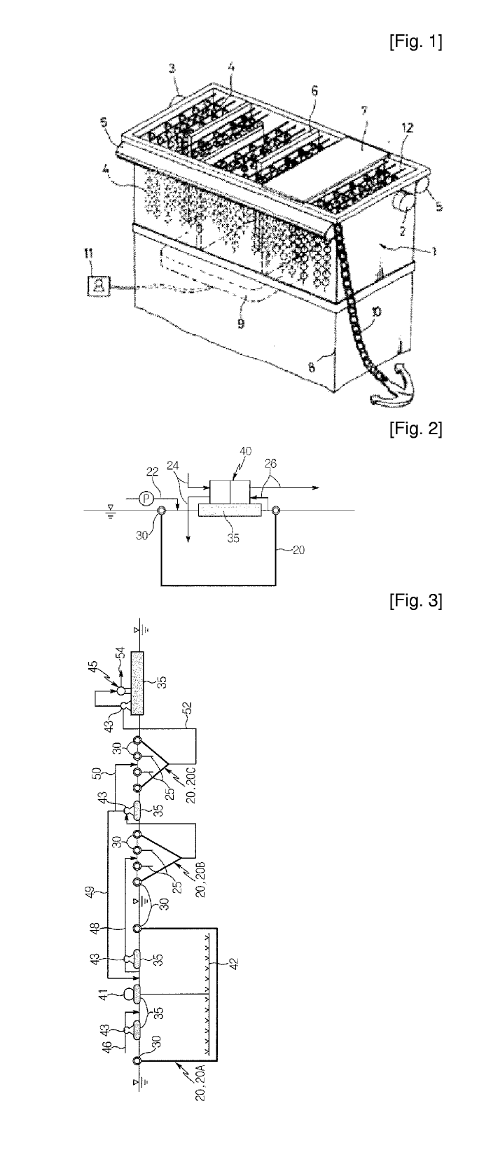

### BEST MODE

Hereinafter, the present invention will be descried in detail with reference to the attached drawings.

FIG. 2 is a schematic view illustrating the basic construction of a water purification apparatus according to the present invention.

Referring to FIG. 2, the water purification apparatus according to the present invention includes a purification tank 20, which is disposed in water in a place such as a lake, marsh, sea, etc., to define a space having a predetermined volume therein, and has a structure such that at least the sidewall and the bottom thereof are closed to contain therein sewage to be purified, a purification unit 40, which is provided inside or outside the purification tank 20 to purify the sewage contained in the purification tank 20, and floats 30 and 35, which support the purification tank 20 and the purification unit 40 such that they are prevented from sinking in the water.

The principal elements of the water purification apparatus of the present invention having the above-mentioned construction will be explained in detail herein below.

The purification tank 20 is manufactured using thin sheets or boards. A frame or the like may be used to support the sheets or boards constituting the purification tank 20.

In detail, the purification tank 20 may be manufactured through a process, in which a frame made of wood, plastic or metal is manufactured and, thereafter, a casing structure, the sidewall and bottom of which are sealed, and which has a predetermined size, is manufactured using sheets or boards made of material, such as waterproof cloth, plastic, rubber or metal, that can be easily shaped.

Furthermore, the purification tank 20 may have various shapes, for example, a cylindrical shape, a conical shape, an elliptical conical shape, a rectangular parallelepiped shape, a hexagonal shape, etc. Preferably, the purification tank 20 has a structure such that the upper end thereof is open.

A single purification tank 20 may be used alone or, alternatively, a plurality of purification tanks 20 may be used together. The construction of the present invention using several purification tanks 20 will be explained in detail in the description of the embodiments, which will be described later herein.

The float 30 serves to prevent the purification tank 20, filled with sewage to be purified, from sinking in the water, thus keeping the sewage in the purification tank 20 separate from the water outside the purification tank 20 such that they are prevented from being mixed with each other.

Preferably, the float 30 is manufactured using a foamed plastic body, an air bladder, a hollow drum can, or the like, and is attached around the upper edge of the purification tank 20 to have a ring shape.

The float 35 may have a barge shape made of a foamed plastic body, an air bladder or the like in order to stably float on water.

Furthermore, the float 30 may have a float ring structure, which is formed by inserting the upper end of the purification tank into a part that is formed into a long tube shape.

It is preferable that the float 30 be constructed such that the height above the surface of the water ranges from 10 cm to 100 cm, but the present invention is not limited to this. In other words, the height to which the float 30 protrudes from the surface of the water may be less than the minimum value of the above range or greater than the maximum value thereof.

Meanwhile, the purification unit 40 may have various structures depending on the deployment conditions, including a physical, biological or chemical water treatment method and the extent and scope of water treatment. Preferably, the purification unit comprises water purification equipment, such as an air blower, a pump, a diffuser and a dehydrator, which constitute a typical water treatment apparatus.

In FIG. 2, the reference numerals 22, 24 and 26 respectively denote a sewage supply line 22, through which sewage to be purified is drawn into the purification tank 20, a pumping line 24, which supplies air, a coagulation treatment agent or microbial nutrients into the purification tank 20, and a discharge line 26, which discharges water, treated by passing the purification unit 40, outside the purification tank 20.

The basic operation of the water purification apparatus according to the present invention having the above-mentioned construction will be described herein below.

The water purification apparatus of the present invention uses Archimedes' principle, which will be explained herein below.

The pressure applied to the surface of an object at a depth h in the water surface is given by ρgh, which denotes a value multiplied by the density (ρ) of water, the acceleration of gravity (g) and the depth (h) in the water. If two water systems are partitioned by a partition wall, for example, in the present invention, in the case where the two water systems are partitioned by the sidewall of the purification tank 20, when the heights from one point on the partition wall to the water surfaces of the two water systems that contact the respective opposite surfaces of the partition wall differ from each other, and, thus, when the height on one surface of the partition wall is designated by h₁ and the height on the other surface of the partition wall is designated by h₂, the pressure at this point is given by ρg(h₁−h₂). This difference in pressure on opposite sides is expressed as a force which is called “buoyancy”. The buoyancy corresponds to an upward force equal to the weight of the water of the outer water system, which is displaced by the object defined by the partition wall. This buoyancy supports the object defined by the partition wall.

In the case where the water levels inside and outside the partition wall are equal to each other, the pressures applied to the opposite surfaces of the partition wall are equal to each other. At this time, because there is no difference in pressure on the opposite sides of the partition wall, tension applied to the partition wall is zero. If the difference between water levels on the opposite sides of the partition wall is 10 cm, because the density of water is 1 gf/cm³, the pressure applied to the partition wall is 10 gf/cm³, which is relatively low. Therefore, in the case where the difference between the water level of the inner water system surrounded by the partition wall and the water level of the outer water system is relatively small, although the partition wall is made of material having a relatively low stiffness, it can maintain its shape and function without being deformed.

Although the purification tank 20 of the present invention is also made of a waterproof sheet, such as waterproof cloth, plastic, rubber, etc., in the same manner as that of the partition wall in the above description illustrating the Archimedes' principle, it can be stably placed in water while containing sewage therein.

That is, the purification tank 20 of the present invention is filled with sewage to be purified and with aggregated microbes for purifying pollutants, and is disposed at a predetermined position in a lake, marsh, harbor or river, thus serving as a superior sewage treatment structure.

Meanwhile, one or a combination of an activated sludge process, a submerged biofilter process and coagulation sedimentation, which are well known, may be used for realizing the sewage treatment system in the present invention. When sewage is treated through such a treatment process, BOD and COD substances and eutrophic substances such as nitrogen and phosphorus in the sewage are oxidized and resolved by the activity of microbes, or accumulate in the bodies of the microbes and, thereafter, are removed from water through a process of removing microbes along with sludge. As a result, the sewage, which has been polluted, is reliably purified.

### MODE FOR INVENTION

Hereinafter, preferred embodiments of the water purification apparatus of the present invention using the above-mentioned principle will be described in detail with reference to the attached drawings.

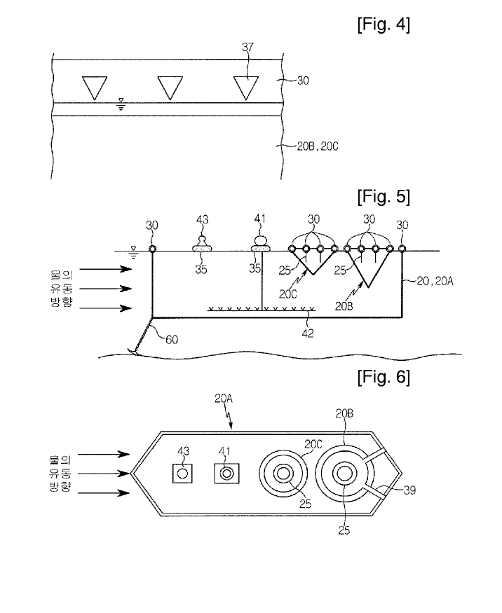

First, a first embodiment of the present invention will be explained herein below with reference to FIGS. 3 and 4.

FIG. 3 is a schematic side view showing the construction of a water purification apparatus according to the first embodiment of the present invention. The construction of the first embodiment is suitable for a place such as a lake or marsh, where there is little flow of water. Furthermore, several purification tanks 20 are arranged in series such that water treatment is conducted in stages.

Referring to FIG. 3, the purification tanks 20 comprise a reaction purification tank 20A, a sedimentation purification tank 20B, and a concentration purification tank 20C, which are arranged in series and are coupled to each other. In addition, various kinds of purification devices, such as an air blower 41, a pump 43, a diffuser 42 and a dehydrator 45, which are required for water purification, are provided inside or outside the purification tanks 20.

Each device will be explained in detail herein below.

The reaction purification tank 20A is a tank, which has a predetermined volume and a sealed sidewall and bottom. The reaction purification tank 20A may have various shapes, for example, a cylindrical shape, a conical shape, an elliptical conical shape, a rectangular parallelepiped shape, a hexagonal shape, etc. A float 30 having a ring shape is provided around the upper edge of the reaction purification tank.

The float 30 serves to prevent the reaction purification tank 20A, which contains therein sewage, which is the material to be treated, from sinking in the water and separates the sewage in the reaction purification tank 20A from the outside water such that they are prevented from being mixed with each other. Furthermore, it is preferable that the float 30 be constructed such that the height above the surface of the water ranges from 10 cm to 100 cm.

The air blower 41 is placed on a float 35, which has a barge shape and is made of a foamed plastic body, an air bladder, or the like, thus floating on water. The air blower 41 is coupled to the diffuser 42, which is provided in the water.

In FIG. 3, the reference numeral 43 denotes the pump for carrying water, and 46 denotes a sewage supply pipe.

The sedimentation purification tank 20B is manufactured through a process in which a casing is manufactured using a frame and sheets in the same manner as the reaction purification tank 20A and floats 30 are provided around the upper edge of the sidewall of the casing. A sheet, in which reversed triangular holes are formed and arranged at regular intervals, is attached between the adjacent floats 30, so that water, which has been treated, overflows outside through the reversed triangular holes.

In detail, FIG. 4 is a detailed view illustrating the above-mentioned overflow structure. Referring to the drawings, several overflow holes 37, which have reversed triangular shapes such that water in the purification tank 20 can overflow outside, are formed through any one of the casing of the sedimentation purification tank 20B and each sheet between the floats 30. Here, preferably, the overflow holes are formed such that each lower end thereof is disposed at a position higher than the water surface by a predetermined distance.

Furthermore, the sedimentation purification tank 20B is manufactured to have a conical shape or a pyramidal shape, and a hard pipe connected to the pump is coupled to the pointed lower end of the sedimentation purification tank 20B, so that concentrated sludge is transmitted through the hard pipe by the pump. In addition, a cylindrical partition body 25, which is open on upper and lower ends thereof and is coupled at the upper edge thereof to a separate float 30, is provided in the sedimentation purification tank 20B. Thus, treated water containing activated sludge is drawn into the partition body 25 from the reaction purification tank 20A through a sludge-containing-water pipe 48.

The concentration purification tank 20C is manufactured to have the same shape as that of the sedimentation purification tank 20B and is preferably relatively small, having a size ranging from ½ to ¼ of that of the sedimentation purification tank 20B. A cylindrical partition body 25, which is open on upper and lower ends thereof, may also be installed in the concentration purification tank 20C, in the same manner as that of the sedimentation purification tank 20B.

Meanwhile, preferably, the dehydrator 45 is provided at a position adjacent to the concentration purification tank 20C. A well known activated-sludge-vacuum dehydrator may be used as the dehydrator 45. As well, preferably, the dehydrator 45 is placed on a float 35, which has a barge shape and is made of a foamed plastic body, an air bladder or the like, thus floating on water.

The first embodiment of the water purification apparatus according to the present invention is operated as follow.

Sewage that must be purified is drawn into the reaction purification tank 20A through the sewage supply pipe 46 by the pump 43 and is purified in the reaction purification tank 20A by the action of activated sludge between oxygen supplied through the diffuser 42. Thereafter, it is carried into the partition body 25 in the sedimentation purification tank 20B through the sludge-containing-water pipe 48.

The supplied treated water containing sludge is treated through a sedimentation process in the sedimentation purification tank 20B. Then, surface water overflows outside the sedimentation purification tank 20B and enters the lake, marsh, river or sea, and some of the submerged sludge is returned into the reaction purification tank 20A through a return sludge pipe 49 while remaining sludge is carried into the partition body 25 in the condensation purification casing 20C through a surplus sludge pipe 50. At this time, as necessary, a coagulation treatment agent may be supplied into the surplus sludge pipe 50. Typically, the water level in each of the sedimentation purification tank 20B and the concentration purification tank 20C is maintained at a position higher than that of the outside water by 5 to 10 cm, such that the overflow process can be smoothly conducted. In addition, the flow rate of the pump for carrying treated water containing sludge is controlled such that the water level in the reaction purification tank 20A is as close as possible to the level of the outside water.

Sludge concentrated in the concentration purification tank 20C is supplied to the dehydrator 45 through a concentrated sludge pipe 52 by the pump 43 and is thereafter dehydrated by the dehydrator 45. Subsequently, caked waste sludge is collected as a predetermined unit and is exhausted through a discharge unit 54.

Next, a second embodiment of the present invention will be described herein below with reference to FIGS. 5 and 6.

FIGS. 5 and 6, respectively, are a schematic side view and a schematic plan view showing the construction of a water purification apparatus according to the second embodiment of the present invention. The construction of the first embodiment is suitable for a place such as a river or sea, where water is relatively swift. Furthermore, the first embodiment is constructed such that purification tanks 20B and 20C are received in a purification tank 20A.

Referring to FIG. 6, in this embodiment, the reaction purification tank 20A has a streamlined structure having a relatively large hexagonal cross-section. In other words, the reaction purification tank 20A has the hexagonal shape, in which the width thereof is reduced from the medial portion thereof to front and rear ends in the direction in which water flows, thus reducing the resistance to the flow of water when it is installed in a river. Here, the shape of the reaction purification tank 20A is not limited to the hexagonal shape, but may be have a streamlined shape and rounded sidewalls.

Particularly, in this embodiment, all equipment, including the sedimentation purification tank 20B and the concentration purification 20C, an air blower 41, a pump 43, a diffuser 42 and a dehydrator (not shown), are disposed in the reaction purification tank 20A. That is, although it is schematically shown in the drawings, it is to be appreciated that the second embodiment is to be provided with all purification devices required for purifying water, in the same manner as the above-described first embodiment, but, unlike the first embodiment, in the second embodiment, the purification devices are installed in the reaction purification tank 20A.

Furthermore, in the second embodiment, an overflow water passage 39 having a channel structure may be coupled to each of the tanks including the sedimentation purification tank 20B, such that, when water that has been treated overflows outside through the overflow hole of each tank, the overflow water can be discharged outside the reaction purification tank 20A through the overflow water passage 39.

Here, preferably, the overflow water passage 39 is formed using a typical pipe or hose structure.

Meanwhile, in consideration of the installation location of the reaction purification tank 20A where water is relatively swift, it is preferable that a mooring unit 60 for mooring the reaction purification tank be mounted to one end thereof.

### INDUSTRIAL APPLICABILITY

As described above, the present invention provides a water purification apparatus, which can be used in a water treatment system that purifies supplied sewage to improve the water quality pollution state of a lake, marsh or a river, and can be disposed on the water through a simple installation process. Furthermore, the water purification apparatus can efficiently treat sewage in an environmentally friendly manner, even if the sewage contains a lot of biological or chemical oxygen demand substances (BOD or COD substances), floating substances or eutrophic substances such as nitrogen and phosphorus.

In addition, in the water purification apparatus according to the present invention, a purification tank having a water treatment space defined therein is provided in water using Archimedes' principle. Therefore, compared to sewage treatment equipment that comprises a large concrete structure placed on the ground, construction expenses can be markedly reduced, the manufacturing process is simplified, the apparatus is portable, and the disposal process is also simplified. As well, because the apparatus is not located on the ground, the present invention optimizes use of space.

1. A water purification apparatus, comprising:
a purification tank disposed in water of a lake, marsh, river or sea to define a space having a predetermined volume therein, the purification tank being closed on at least a sidewall and a bottom thereof to contain sewage to be purified therein such that the sewage is separated from the outside water;
purification devices provided inside or outside the purification tank to purify the sewage contained in the purification tank; and
a float supporting the purification tank and the purification devices to prevent the purification tank and the purification devices from sinking in the water.

2. The water purification apparatus according to claim 1, wherein the purification tank is manufactured using a relatively thin sheet or board.

3. The water purification apparatus according to claim 1, wherein the purification tank is constructed such that a width thereof is reduced from a medial portion thereof to at least one end thereof with respect to a direction in which the water flows, to reduce resistance against flow of the water.

4. The water purification apparatus according to claim 1, wherein the float is provided around an upper edge of the purification tank to have a ring shape, such that the water in the purification tank is separated from the water outside the purification tank.

5. The water purification apparatus according to claim 1, wherein an overflow hole is formed through at least one of the purification tank and the float, so that the water in the purification tank overflows outside through the overflow hole.

6. The water purification apparatus according to claim 1, wherein the purification tank comprises a plurality of purification tanks, and
the purification devices comprise water purification equipment including an air blower, a pump, a diffuser and a dehydrator, which are required to purify the water.

7. The water purification apparatus according to claim 1, wherein the purification tank comprises a reaction purification tank, a sedimentation purification tank and a concentration purification tank, which are arranged in series and coupled to each other such that water treatment is conducted in stages, and
the purification devices for purifying the water are disposed inside or outside the purification tanks.

8. The water purification apparatus according to claim 1, wherein the purification tank comprises a plurality of purification tanks, and the purification tanks are coupled to each other in series.

9. The water purification apparatus according to claim 1, wherein the purification tank comprises a plurality of purification tanks, and the purification tanks are coupled to each other to form a structure such that one purification tank receives remaining purification tanks therein.
